(19) United States
(12) Patent Application Publication
(10) Pub. No.: US 2011/0160951 A1
(43) Pub. Date: Jun. 30, 2011

(54) Control Unit for Gateway and Automotive Control System

(75) Inventors: Tasuku Ishigooka, Hitachi (JP); Fumio Narisawa, Hitachinaka (JP); Junji Miyake, Hitachinaka (JP); Wataru Nagaura, Hitachinaka (JP)

(73) Assignee: Hitachi, LTD., Tokyo (JP)

(21) Appl. No.: 12/973,030

(22) Filed: Dec. 20, 2010

(30) Foreign Application Priority Data
Dec. 25, 2009 (JP) 2009-293709

(51) Int. Cl. G06F 7/00

(52) U.S. Cl. 701/29; 701/1; 701/36

(57) ABSTRACT

The automotive control system includes a first subsystem, a second subsystem and an adaptive cruise control system. The first and second subsystems and the adaptive cruise control system are interconnected through their gateway ECUs and the FlexRay. Each of the gateway ECUs has a time tagging unit that tags the received data with time information of their reception.

### BACKGROUND OF THE INVENTION

The present invention relates to an automotive control system or a device for relaying data on a network in an automotive control system.

Many automotive control system in recent years include an ECU (Electronic Control Unit) for operating an automotive electronic control device and a in-vehicle LAN (Local Area Network) that enables communication among a plurality of ECUs. One of such on-board LANs is a widely used network called CAN (Controller Area Network).

However, as an automotive system to reduce environmental burden becomes highly sophisticated, the communication bandwidth available is running low. In such situations, FlexRay (registered trademark), a LAN with a greater communication capacity than the CAN, is being used. The FlexRay has about 10 times the transmission rate of the CAN and thus can transmit a large volume of data.

The automotive control system includes a plurality of networks, such as CAN, an event-triggered network that transmits data non-periodically, and FlexRay, a time-triggered network that transmits data periodically, and is a processing-integrated control system that makes a plurality of ECUs cooperate with one another through the network in executing processing.

For data communication through such networks, gateway ECUs that relay data among the plurality of networks, i.e., gateway control units, are needed.

In a safety critical system that demands a high standard of safety, such as an automotive control system, there needs to be executed error notification processing that involves detecting an abnormal state of the car resulting from ECU failures or the like and stopping those functions that will affect the automotive control. Another processing that needs to be done is one that logs abnormal states of the vehicle for later analysis of details of anomaly during a maintenance service. Particularly, in order to prevent the integrated control system from performing erroneous control based on old control information (i.e., data to be used for control) that has failed to be updated for some time because of an ECU fault, there is a growing demand for a capability of detecting old control information that has failed to be updated for more than a predetermined duration.

To meet this demand, a method has been proposed (e.g., JP-A-2007-38782) which, in handling data in one ECU, involves storing data acquisition time information for detection of old data and, during a calculation using the time-tagged data, comparing the current time held by the ECU with the data acquisition time to prevent the old control information from being used.

Another method has also been proposed (e.g., JP-A-2007-238044 corresponding to U.S. Patent Publication No. 2007/213888) which, when control data is received, tags it with the time information and, when that data is actually used, compares the current time of the node with the time information of the data to confirm the data is valid, thus preventing the use of old control data.

### SUMMARY OF THE INVENTION

If the methods described above are to be applied to the automotive integrated control system, significant changes need to be made to the system, such as adding processing for tagging data with a data acquisition time to the ECU that performs the automotive control.

The present invention has been accomplished in consideration of these problems and it is an object of this invention to improve gateway control units that relay data in a network of the automotive integrated control system so that validity of control information obtained during a predetermined period of time from sensors and by control operations can be verified.

To achieve the above objective, this invention provides a control unit for gateway used in an automotive control system, wherein the automotive control system has a plurality of control units and a network connecting the plurality of control units and compares time information attached to a plurality of pieces of control information flowing on the network to verify a validity of the plurality of pieces of control information, the control unit for gateway comprising at least one of two units: a time tagging unit which receives a plurality of pieces of control information transmitted from one of the plurality of control units and tags them with time information; and a time information comparison unit which makes comparison between a plurality of pieces of the time information that the time tagging unit has attached to the plurality of pieces of control information received.

As described above, the automotive integrated control system according to this invention can verify the validity of control information while limiting changes to the system.

Other objects, features and advantages of the invention will become apparent from the following description of the embodiments of the invention taken in conjunction with the accompanying drawings.

### BRIEF DESCRIPTION OF THE DRAWINGS

FIG. 1 shows a device configuration of a commonly available ECU.

FIG. 2 shows a configuration of an automotive control system as embodiment 1.

FIG. 3 shows a gateway ECU having both data relaying processing and car control processing.

FIG. 4 shows how the gateway ECU's time is synchronized with a communication cycle of FlexRay.

FIG. 5 shows how a synchronization reference signal is transmitted to FlexRay to synchronize the gateway ECU's time with the reference signal transmitted.

FIG. 6 is a flow chart showing timer synchronization processing performed by gateway ECU.

FIG. 7 shows how time information is given to the gateway ECU when it receives vehicle speed information.

FIG. 8 is a flow chart showing processing performed by the gateway ECU to relay control information received from CAN.

FIG. 9 shows how a system anomaly or error is detected by the gateway ECU comparing vehicle speed information and information on distance to a car in front when they are received.

FIG. 10 is a flow chart showing processing performed by the gateway ECU to relay control information received from FlexRay.

FIG. 11 shows an ECU, other than the gateway ECU, having time comparison processing.

FIG. 12 shows an example data structure used in embodiment 1 when data is relayed from CAN to FlexRay.

FIG. 13 shows a configuration of the automotive control system in embodiment 2.

FIG. 14 shows a configuration of the automotive control system in embodiment 3.

### DESCRIPTION OF THE EMBODIMENTS

In the handling of data within one ECU (control unit) aboard a car, the method of comparing the data acquisition time with the current time held by the ECU can be applied as is to the detection of old control information within the single ECU. However, when the control information is transmitted through network and used by other ECU than that which has acquired the control information, as will occur in an automotive integrated control system, the validity of the control information, for example, in terms of whether it is old or new or whether it has any error cannot be determined.

In the automotive integrated control system, the method of verifying the validity of control information by using the time that has passed from the control information acquisition time has a problem that the time of the ECU, which has attached the time information to the control information, may not be synchronized with the current time held by other ECU that uses the control information. As a result, comparison cannot be made between the time information tagged to the control information and the current time of other ECU. Furthermore, if a new function of tagging the control information acquisition time is added to each ECU, when, on a network not including time information, an ECU sending the control information is connected with an ECU that relays data to other network, such as FlexRay, the time information additionally flows over the network where it is not supposed to be transmitted, creating an additional communication traffic. In addition, this also necessitates the redesigning of a system that has already been developed, including the addition of a time information tagging function to each ECU.

In a system that controls cars by communicating data among a plurality of ECUs, this invention focuses its attention, not on verifying the validity of control information based on the time when the control information is acquired at each ECU, but on adding a time tagging function to a control unit for gateway and detecting errors in the system based on the time when the control unit for gateway has received the control information from the ECU and relayed it.

Embodiments of this invention will be described in detail by referring to the accompanying drawings.

### EMBODIMENT 1

A first embodiment of the automotive control system and ECU according to this invention will be explained in detail by referring to the drawings.

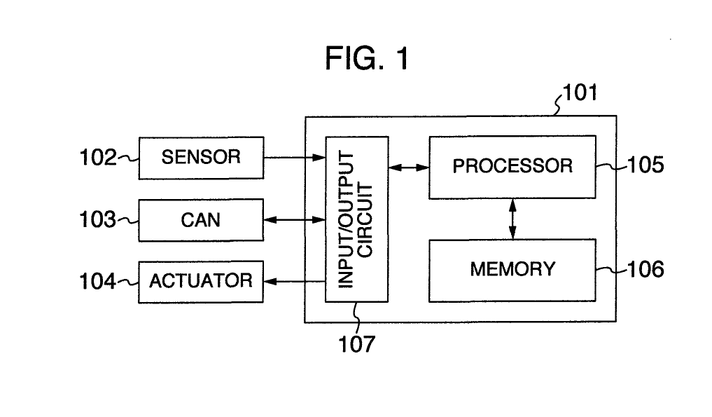

FIG. 1 shows an outline configuration of a commonly used ECU. ECU 101 has an input/output circuit 107 to input and output data to and from external circuits, a processor 105 for arithmetic operations and a memory 106 to store data. The processor 105 reads and writes programs and control information to and from the memory 106 to execute arithmetic operations for automotive control. Communication of data with the external circuits outside the ECU is performed via the input/output circuit 107. For example, a car driving state and behaviors of devices to be controlled are input from a sensor 102 through the input/output circuit 107. When the ECU 101 receives control information from other ECU or when it transmits control information that it has acquired or calculated to other ECU, the data communication is done via the input/output circuit 107 and a network, such as CAN 103 and FlexRay, or a communication bus. Based on a variety of pieces of control information, ECU 101 outputs a control signal through the input/output circuit 107 to an actuator 104 to be controlled.

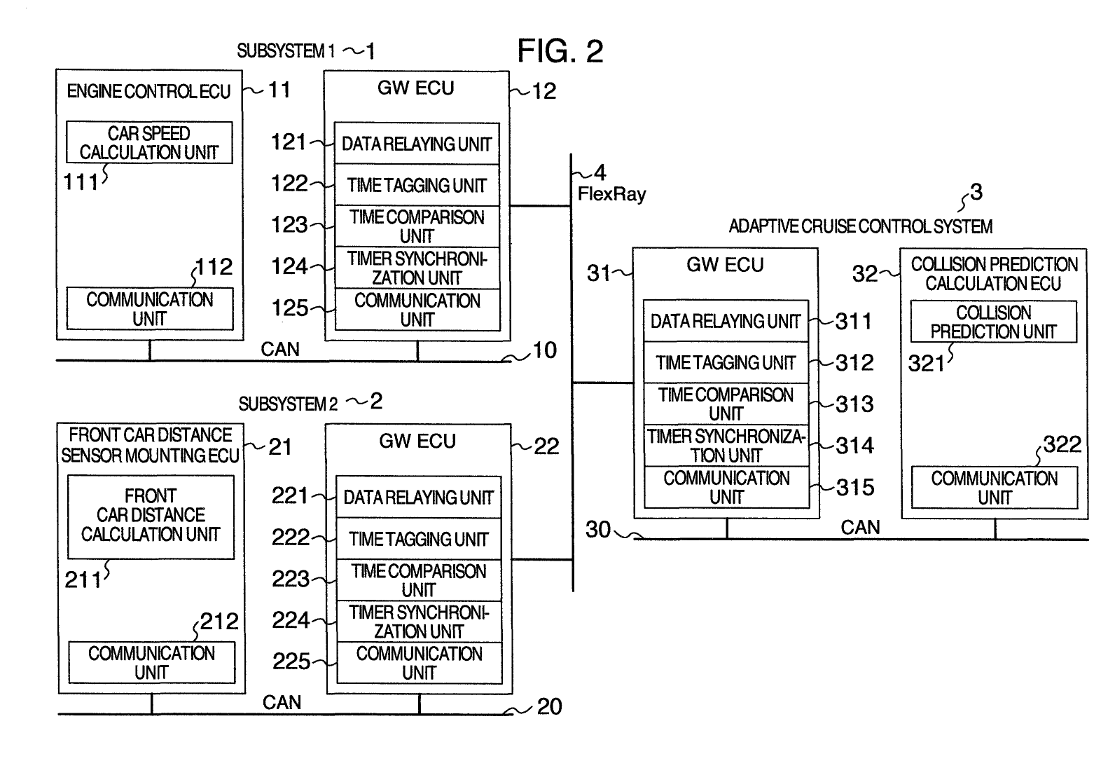

FIG. 2 shows an automotive control system as one embodiment of this invention. The system shown here as one example of an automotive integrated control system controls a distance to a car in front. The automotive control system includes a subsystem 1, a subsystem 2 and an adaptive cruise control system 3. The adaptive cruise control system is also one of subsystems. The subsystem includes one or more ECUs that are specific to the control of a particular device, a network connecting ECUs (e.g., CAN and communication bus), and a control unit for gateway (gateway ECU) that relays data to other networks. For instance, the subsystem 1 includes an engine control ECU 11, a gateway ECU 12 and a CAN 10; the subsystem 2 includes a front car distance sensor mounting ECU 21, a gateway ECU 22 and a CAN 20; and the adaptive cruise control system 3 includes a gateway ECU 31 and a collision prediction calculation ECU 32. The subsystems 1, 2 and the adaptive cruise control system 3 are interconnected through their respective gateway ECUs on FlexRay 4, a network connecting these subsystems. It is noted here that there is a difference between the CAN and the FlexRay in that the CAN is an event-triggered network over which no time information is communicated while the FlexRay is a time-triggered network with a communication cycle over which time information is communicated.

The engine control ECU 11 belonging to the subsystem 1 not only performs the engine control but also calculates a vehicle speed and sends the vehicle speed information to the collision prediction calculation ECU 32. Therefore, the engine control ECU 11 has in its memory a vehicle speed calculation unit 111 and a communication unit 112 for sending the result calculated by the vehicle speed calculation unit 111 to the CAN 10. The processor reads data from these units for further processing.

The gateway ECU 12, as described above, relays the vehicle speed information received from the CAN 10 to the FlexRay 4. For this purpose, the gateway ECU 12 has a data relaying unit 121 in its memory, as do other ECUs. As explained later, the gateway ECU 12 also has a time tagging unit 122, a time comparison unit 123, a timer synchronization unit 124 and a communication unit 125 that receives the vehicle speed information from the CAN 10 and transmits it to the FlexRay 4. The gateway ECU can be simplified from the construction of the commonly used ECU shown in FIG. 1, as by omitting the input/output circuit that receives signals from the sensor and sends them to the actuator. It is noted that, though not shown in FIG. 1, the gateway ECU is connected to two or more networks.

The front car distance sensor mounting ECU 21 belonging to the subsystem 2 calculates a distance to a car in front and sends the front car distance information to the collision prediction calculation ECU 32. For this purpose, the front car distance sensor mounting ECU 21 has a front car distance calculation unit 211 and a communication unit 212 that puts the front car distance information on the CAN 20.

Similarly, the gateway ECU 22 relays the front car distance information received from the CAN 20 to the FlexRay 4. For this purpose, the gateway ECU 22 has a data relaying unit 221. It also has a time tagging unit 222, a time comparison unit 223, a timer synchronization unit 224 and a communication unit 225 that receives the front car distance information from the CAN 20 and sends it to the FlexRay 4.

The gateway ECU 31 belonging to the adaptive cruise control system 3 relays the vehicle speed information and the front car distance information received from the FlexRay 4 to the CAN 30. For this purpose, the gateway ECU 31 has a data relaying unit 311, a time tagging unit 312, a time comparison unit 313, a timer synchronization unit 314 and a communication unit 315 that receives the vehicle speed information and the front car distance information from the FlexRay 4 and puts them on the CAN 30.

The collision prediction calculation ECU 32 receives the vehicle speed information and the front car distance information and predicts a possible collision. For this purpose, the collision prediction calculation ECU 32 has a collision prediction unit 321, that makes a collision prediction from the vehicle speed information and the front car distance information, and a communication unit 322 that receives data from the CAN 30.

When the system is working normally, the collision prediction by the collision prediction calculation ECU 32 uses the vehicle speed information and the front car distance information acquired within a predetermined time of each other. If these two pieces of information are not acquired within a predetermined time of each other, the relevance between the two can no longer be assured and they are considered not to contribute to the prediction of collision.

In this embodiment, since the time tagging unit 312 in the gateway ECU 31 is not used, the time tagging unit may not be provided. This can reduce the amount of memory used in the gateway ECU 31. On the other hand, if the time tagging unit is provided, as in other gateway ECUs, the same specifications as other gateway ECUs can be used, offering advantages such as interchangeability among gateway ECUs and a reduction in the number of development steps. Also in this embodiment, for the sake of simplicity, the transmission of control information from the adaptive cruise control system 3 to the subsystems 1, 2 is not shown, the use of the same specifications for the gateway ECUs allows the system to transmit the control information from the adaptive cruise control system 3 to the subsystems 1, 2 if so required.

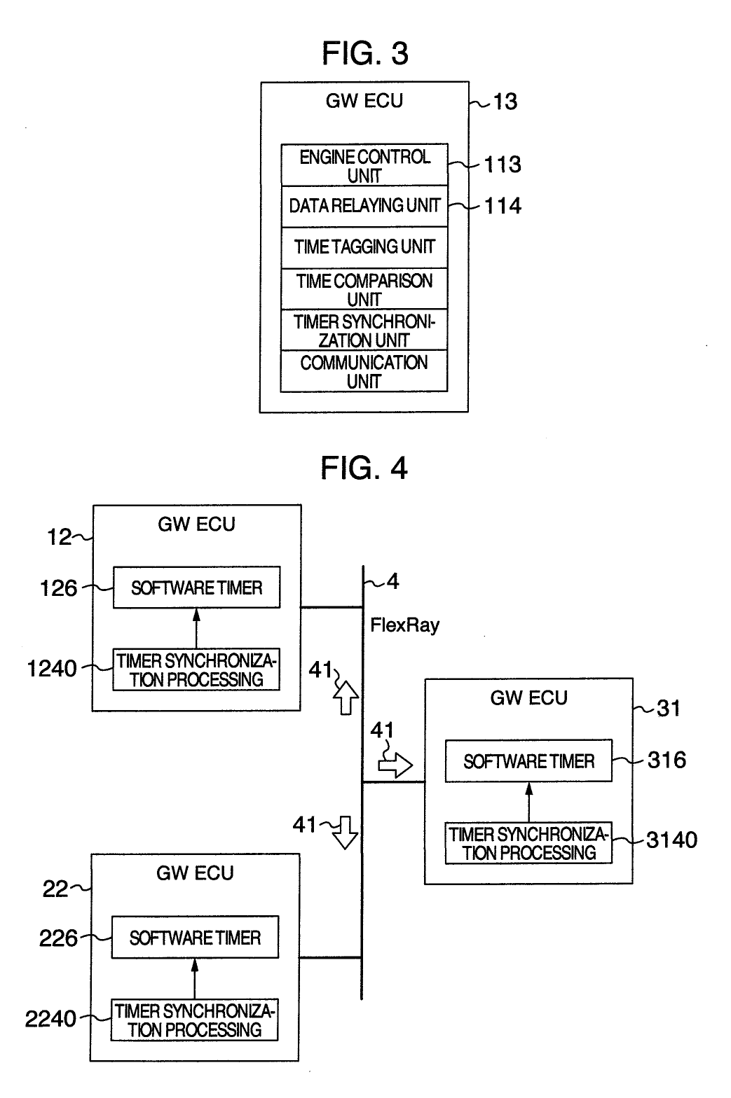

Further, in this embodiment, although the gateway ECU is constructed mainly to relay data, it may also be given other functions such as engine control, as shown in FIG. 3. That is, the gateway ECU can be considered as one kind of ECU. The gateway ECU 13 has an engine control unit 113 and a data relaying unit 114 that relays data from one network to another. At this time, the engine control unit 113 for controlling a particular car and the data relaying unit 114 may be installed either in separate memories so that they are separated from each other in terms of hardware, or in the same memory but separated by software.

FIG. 4 shows an operation flow when gateway ECUs connected to the FlexRay 4 update their own timers in synchronization with the communication cycle 41 of the FlexRay 4. This process allows the automotive control system as a whole to have a common time axis based on the communication cycle of the FlexRay 4. The gateway ECU 12 first calls up timer synchronization processing 1240 of the timer synchronization unit 124 in step with the communication cycle 41 of the FlexRay 4. The timer synchronization processing 1240 then updates a count value of a software timer 126. In this embodiment the timer synchronization is done using the communication cycle (global time) of the FlexRay, and the timer is implemented as a software timer.

As with the gateway ECU 12, the gateway ECU 22 calls up timer synchronization processing 2240 in step with the communication cycle 41 of the FlexRay 4. The timer synchronization processing 2240 updates a value of a software timer 226. The gateway ECU 31, as with the gateway ECU 12 and gateway ECU 22, calls up timer synchronization processing 3140 in step with the communication cycle 41 of the FlexRay 4. The timer synchronization processing 3140 updates a value of a software timer 316. As described above, among the gateway control units connected to at least one time-triggered network, the reference of time for signals flowing on the network is determined and then timers are adjusted based on the time reference to synchronize timers in the entire system. This allows the gateway control units connected to the network to easily synchronize their timers without having to transmit a synchronization signal on the network. Since the synchronization signal does not have to be sent over the network, this synchronization procedure offers an advantage of reducing traffic on the network and overhead on the gateway control units. It also helps reduce changes that need to be made to the system already developed.

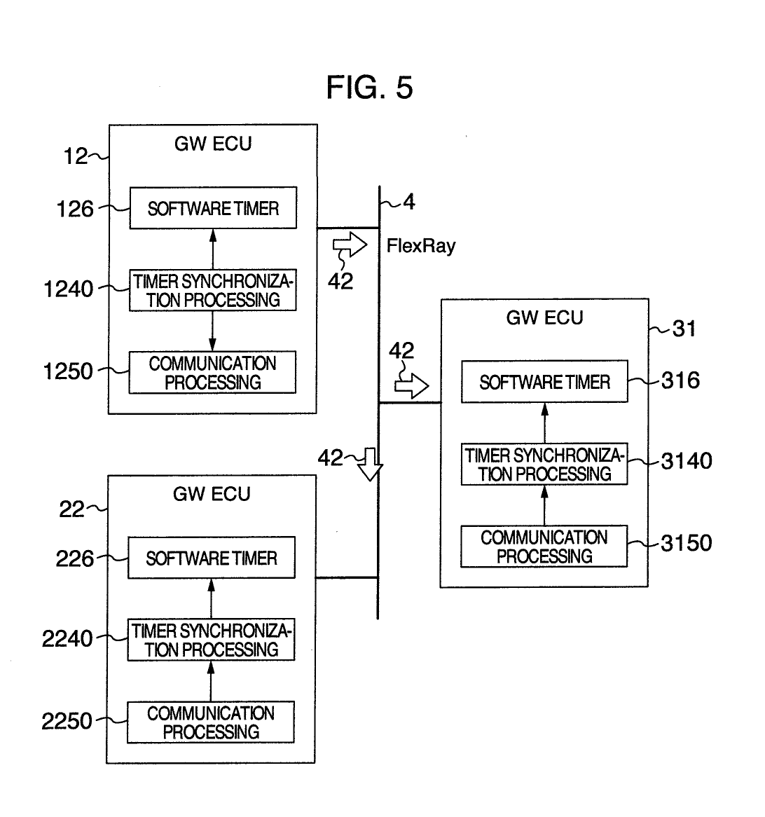

There are methods for synchronizing the timers without using the communication cycle of the FlexRay. One such method conceivable involves sending a timer synchronization signal from each gateway control unit to the FlexRay, as shown in FIG. 5, and synchronizing the timers with that signal. The gateway ECU 12 first calls up the timer synchronization processing 1240 of the timer synchronization unit 124. The timer synchronization processing 1240 updates the value of the software timer 126 and then sends the updated value to the FlexRay 4 by using communication processing 1250 of the communication unit 125. The transmitted timer synchronization signal 42 is received by the gateway ECU 22 and the gateway ECU 31. The gateway ECU 22, upon receiving the timer synchronization signal 42 by communication processing 2250, calls up the timer synchronization processing 2240. The timer synchronization processing 2240 writes the value of the software timer 126 contained in the timer synchronization signal over the software timer 226. The similar processing is done also in the gateway ECU 31 to synchronize its software timer 316 with the software timer 126.

The method of synchronizing the timers based on the communication cycle of the FlexRay in this embodiment, when compared with the above method, has an advantage of lowering the communication traffic in the FlexRay by the communication data volume used in the timer synchronization signal and thus eliminating the overhead in each gateway ECU of sending and receiving the synchronization signal. Furthermore, since, between the ECU sending the timer synchronization signal and the ECU receiving it, there is a difference in time equal to the communication processing time plus the transmission time over the FlexRay, it is difficult to perform the timer synchronization among a plurality of ECUs using the timer synchronization signal. However, if one of the gateway control units connected to the same network sends the synchronization reference signal to the network and the remaining gateway control units adjust their timers according to the reference signal received, the timer synchronization among the gateway control units can be performed irrespective of the kind of network connecting the gateway control units.

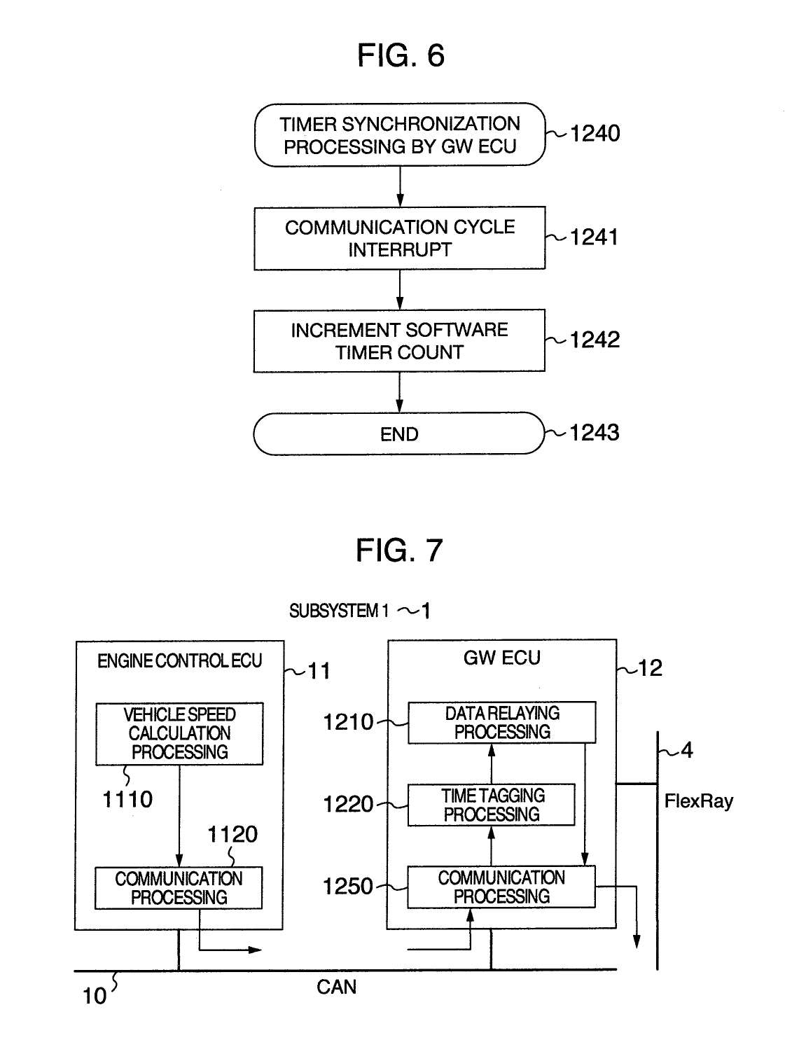

FIG. 6 is a flow chart of the timer synchronization processing 1240 performed in the gateway ECU 12. Referring to this flow chart, a detailed operation flow of the timer synchronization processing 1240 will be explained. The timer synchronization processing 1240 is started by a communication cycle interrupt in the FlexRay communication at step 1241 and then moves to step 1242 where it increments a count of software timer before exiting. The similar processing is also executed in the gateway ECU 22 and gateway ECU 31, so that software timers 126, 226, 316 are synchronized.

The software timers 126, 226, 316 are preferably set to have the same initial values. For example, the initial values of the software timers 126, 226, 316 may be set to 0.

As described above, since in this embodiment the timers are synchronized among the gateway control units that tag the control information with the time information, these gateway control units can tag the common time information.

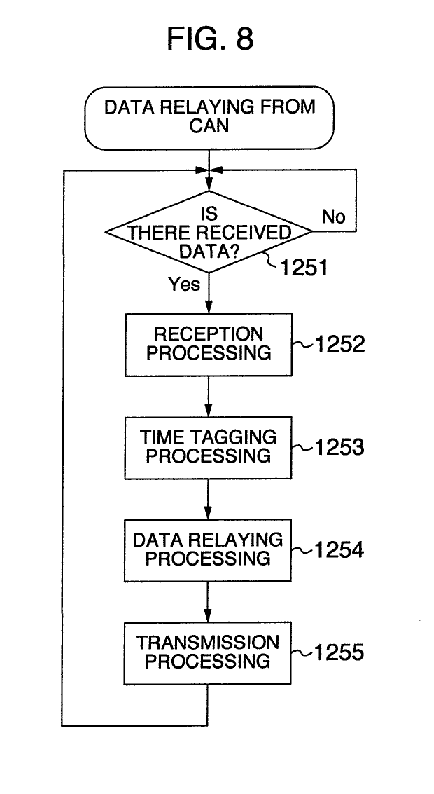

FIG. 7 shows an operation flow in which the gateway ECU 12 tags the vehicle speed information, calculated by the engine control ECU 11 belonging to the subsystem 1, with the time information and relays the time-tagged vehicle speed information to the FlexRay 4. The engine control ECU 11 first calculates the vehicle speed information by the vehicle speed calculation processing 1110 in the vehicle speed calculation unit 111 and then sends the vehicle speed information to the CAN 10 by the communication processing 1120. The gateway ECU 12 receives the vehicle speed information from the CAN 10 by the communication processing 1250. Then the time tagging processing 1220 tags the received vehicle speed information with the current time information held by the gateway ECU 12. The data relaying processing 1210 determines the destination of the time-tagged vehicle speed information and the communication processing 1250 sends it to the FlexRay 4. As described above, the gateway ECU receives the control information from other ECU and, before relaying the data, tags it with the time information. This allows the control information to be tagged with the time information without changing the processing performed by the ECUs other than the gateway ECU and without increasing traffic on the CAN. FIG. 8 shows an example procedure for relaying data from the CAN, as performed in the gateway ECU 12. Referring to this flow chart, a detailed flow of processing by the gateway ECU 12 will be explained. First, it is checked that there is data received from the CAN 10. If there is no received data, step 1251 is repeated. If received data exists, the processing proceeds to step 1252. Step 1252 causes the communication processing 1250 to execute a reception processing to store the received data in memory, before moving to step 1253. Step 1253 is equivalent to the time tagging processing 1220 in the time tagging unit 122 and tags the received data with the time information of the gateway ECU 12 when it has received the data. Then the processing moves to step 1254. Step 1254 is data relaying processing 1210 in the data relaying unit 121 and sets the FlexRay communication information that corresponds to the time-tagged data, before moving to step 1255. The FlexRay communication information represents information required in performing data communication using the FlexRay, such as frame ID and payload of the FlexRay. Step 1255 executes the transmission of the time-tagged data by the communication processing 1250.

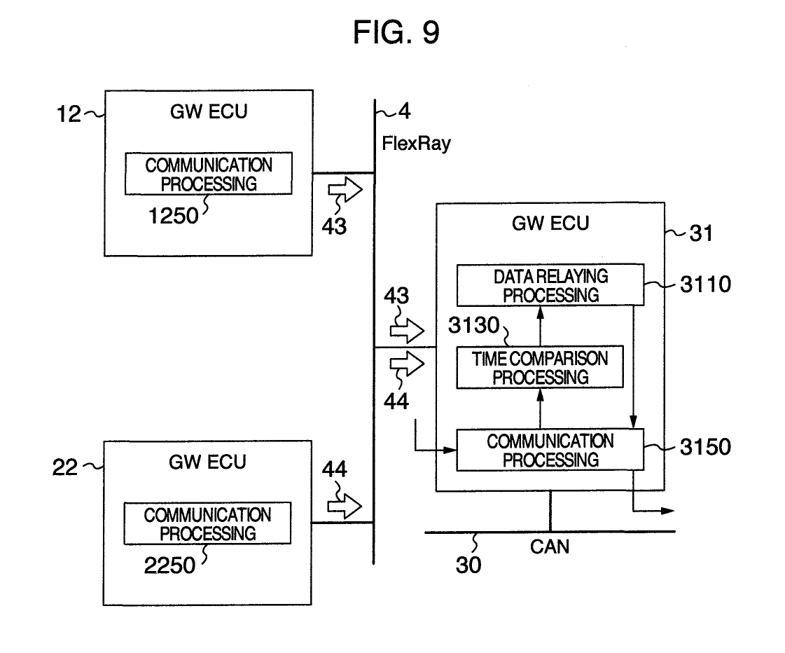

FIG. 9 shows a flow of processing performed in the gateway ECU 31 to detect an error by comparing the time information of the vehicle speed information received from the gateway ECU 12 with the time information of the front car distance information received from the gateway ECU 22. The gateway ECU 12 sends the time-tagged vehicle speed information to the FlexRay 4 by using the communication processing 1250. The gateway ECU 22 similarly sends the time-tagged front car distance information to the FlexRay 4 by using the communication processing 2250. The gateway ECU 31 receives by communication processing 3150 the time-tagged vehicle speed information 43 transmitted from the gateway ECU 12 and the time-tagged front car distance information 44 transmitted from the gateway ECU 22 and then calls up time comparison processing 3130. The time comparison processing 3130 compares the time information of these received information and, if a difference between them is found to be more than a predetermined value, decides that relevance between the two pieces of information cannot be assured and that an error has occurred. On the other hand, if the difference is within the predetermined value, it is deemed as normal. The time comparison processing 3130 then calls up data relaying processing 3110. The data relaying processing 3110 determines the destination of the data received and then puts it on the CAN 30 by using the communication processing 3150.

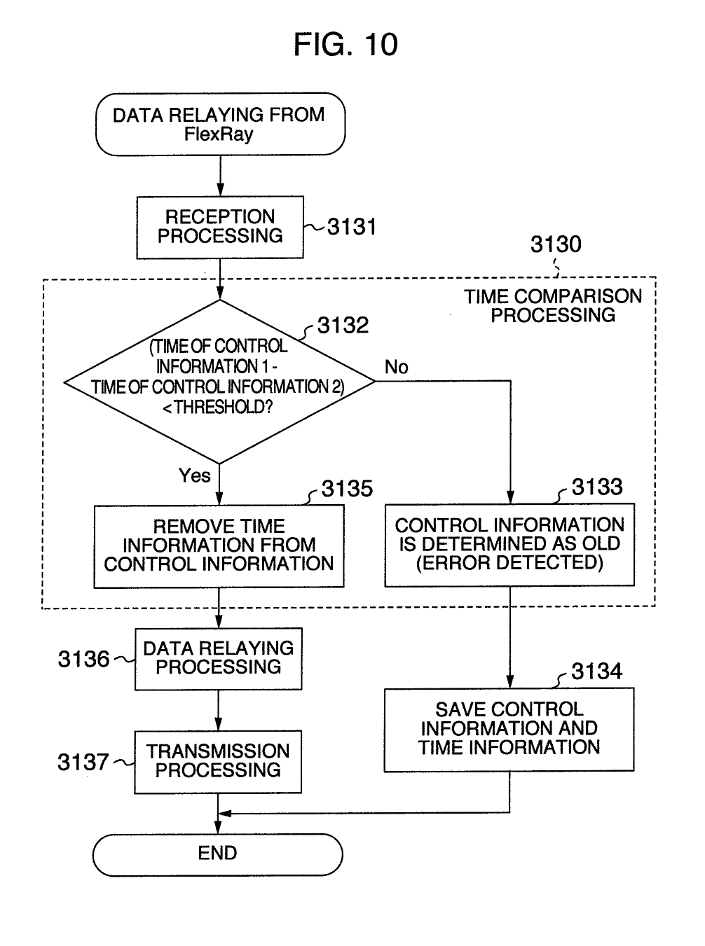

FIG. 10 is a flow chart showing a procedure for relaying data from the FlexRay 4, as performed in the gateway ECU 31. Referring to this flow chart, a detailed flow of processing by the gateway ECU 31 will be explained. The gateway ECU 31 executes reception processing at step 3131 and then moves to step 3132. Step 3132 compares the time information of the first control information received and the time information of the second control information received. In this example, the first control information represents the vehicle speed information and the second control information represents the front car distance information. When the system is working normally, these two pieces of information are acquired within a predetermined time of each other and used for vehicle control. If a difference between the two pieces of time information is found to exceed a time length threshold within which they can be used, the processing proceeds to step 3133. If on the other hand the difference is found not in excess of the time length threshold, the processing moves to step 3135. Step 3133 decides that the data obtained are abnormal because the difference between the two pieces of time information is larger than the time length threshold. The processing then moves to step 3134. This indicates that the two pieces of control information cannot be confirmed to have been acquired within the predetermined period of time of each other, making the relevance between these control information unreliable, which means that an abnormal state has occurred. Step 3134 stores in memory the two pieces of control information that have been determined as erroneous and their time information, before exiting the processing. Although this example procedure, when it determines the data to be erroneous, stores the control information and their time information in memory, other processing is also possible. For example, error notification processing to notify other ECUs of the error may be performed. Further, in this example a comparison is made between two pieces of time information of the control information, the number of pieces of time information to be compared is not limited to two. For example, two or more pieces of the time information of the control information may be compared. If three pieces of time information are compared and if only one of them differs from others, it is possible to decide that the differing one is abnormal. Further, when one of the two pieces of time information to be compared fails to be received or when data received is not different from the previous one, the system may be determined as faulty. This allows a system anomaly to be detected even when the time information to be compared has not been received for a predetermined period.

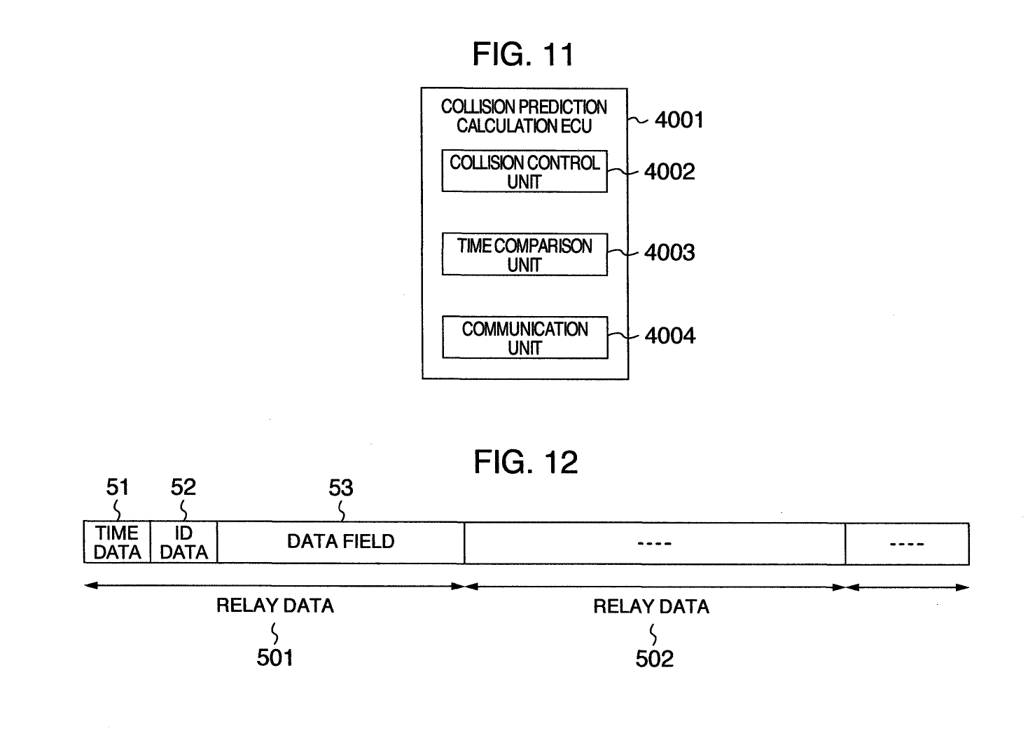

Step 3135 is executed when the difference between the two pieces of control information is less than the time length threshold. Step 3135 removes the time information from the control information and moves to step 3136. Although in this embodiment the gateway ECU 31 removes the time information from the control information, the time information may not be removed. This may be selected according to the kind of destination network to which the data is relayed. For example, if the destination network is an even-driven network, the time information may preferably be removed in consideration of the communication traffic in the destination network. If an ECU that receives the control information and the time information from the CAN 30 is a collision prediction calculation ECU 4001 that has a time comparison unit similar to that of the gateway ECU, as shown in FIG. 11, the comparison between the two pieces of time information can be done again by the time comparison unit 4003 to detect a system error, although this method increases the traffic in the communication bandwidth of the CAN 30 by not removing the time information. Executing the comparison operation twice by different ECUs, as described above, makes a system error detection more reliable than the one-time comparison operation.

Step 3136 is the data relaying processing 3110 that determines the destination based on the two pieces of control information. The processing then moves to step 3137. Step 3137 is the communication processing 3150 and sends the control information to the CAN 30. The data relaying processing is then exited. As described above, a system error is detected by comparing the time information of the control information.

An example of data flowing in the network of this embodiment is shown in FIG. 12. The relay data 501, 502 each include the control information to be forwarded to the FlexRay. The two pieces of control information in the relay data may or may not be related to each other. The number of pieces of relay data transmitted at one time may be one or two or more. It is advantageous in terms of managing and comparing the control information to put the related control information in the adjoining relay data during the relaying operation. These relay data have data sizes larger than the data field received from the CAN.

ID data 52 is used by the FlexRay to identify the data field relayed from the CAN (e.g., CAN ID+DLC, system data ID, etc.). The data field 53 is the one relayed from the CAN and includes the control information.

Time data 51 is the time information tagged by the time tagging processing 1220, i.e., the time at which the relay data was received or the time at which it was relayed to the FlexRay. The time data 51 is paired with the control information contained in the relay data. The reference time used is the time synchronous among the gate ECUs connected to the FlexRay, such as the time synchronized by the timer synchronization processing explained in FIG. 4 and FIG. 5 or the global time of the FlexRay.

FIG. 12 shows an example data structure when the data is relayed from the CAN and the FlexRay. This invention can also employ a network having other communication protocol than the CAN, such as a communication bus. In that case, if the size of data relayed by a gateway ECU exceeds the data size that can be transmitted in one frame of the FlexRay (254 bytes), additional processing needs to be executed which involves the sending gateway ECU dividing the data and transmitting them and the receiving gateway ECU, such as one that executes the time comparison processing, connecting the divided data. Further, it is also possible to employ a network of other communication protocol than that of the FlexRay. In that case, some provisions need to be made, such as the one explained in FIG. 5, to synchronize timers of those gateway ECUs not using the global time of the FlexRay.

In this embodiment, since at least two pieces of time information tagged to the control information are compared in the gateway control unit, the validity of these control information can be determined. Further, since the time information tagged to the control information are compared, a system error can be detected even when an ECU that has tagged the time information and an ECU that compares the time information differ. Furthermore, since in this embodiment the gateway control unit, when it receives the control information from a first network (e.g., CAN), sends to a second network (e.g., FlexRay) the control information and the time information on control information reception, this method offers an advantage of producing smaller traffic on the network than when the control information and the time information are transmitted over the first network.

### EMBODIMENT 2

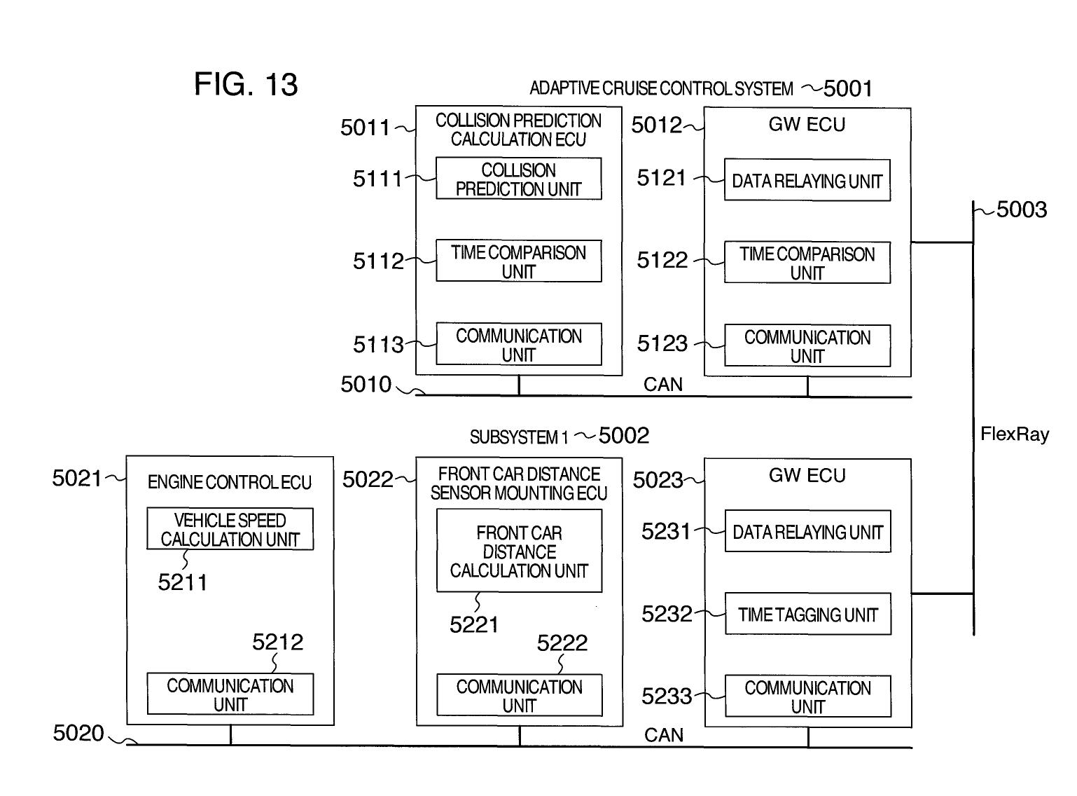

An example of an automotive control system having the similar processing to those of embodiment 1 but differing in configuration from embodiment 1 is shown in FIG. 13.

The automotive control system of FIG. 13 includes an adaptive cruise control system 5001 and a subsystem 5002. The adaptive cruise control system 5001 includes a collision prediction calculation ECU 5011 and a gateway ECU 5012; and the subsystem 5002 includes an engine control ECU 5021, a front car distance sensor mounting ECU 5022 and a gateway ECU 5023. The collision prediction calculation ECU 5011 has a collision prediction unit 5111, a time comparison unit 5112 and a communication unit 5113; and the gateway ECU 5012 has a data relaying unit 5121, a time comparison unit 5122 and a communication unit 5123. The engine control ECU 5021 has a vehicle speed calculation unit 5211 and a communication unit 5212; the front car distance sensor mounting ECU 5022 has a front car distance calculation unit 5221 and a communication unit 5222; and the gateway ECU 5023 has a data relaying unit 5231, a time tagging unit 5232 and a communication unit 5233.

Unlike embodiment 1, this embodiment has the same gateway ECU relay the vehicle speed information and the front car distance information. The gateway ECU 5023 tags the vehicle speed information and the front car distance information received from the CAN 5020 with time information by the time tagging unit 5232 and then sends them to the FlexRay 5003 using the communication unit 5233. The gateway ECU 5012 receives the vehicle speed information and the front car distance information, both containing time information, by using the communication unit 5123 and then compares the time information of these control information by the time comparison unit 5122. If, as a result of the comparison, it is decided that these control information are not erroneous, the gateway ECU 5012 sends the time-tagged vehicle speed information and front car distance information to the CAN 5010 using the communication unit 5123. The collision prediction calculation ECU 5011 receives the vehicle speed information and the front car distance information, both containing time information, by using the communication unit 5113 and then compares the time information of these control information by the time comparison unit 5112. If the comparison finds that these control information are not erroneous, they are used by the collision prediction unit 5111.

In this embodiment, unlike embodiment 1, since the same gateway ECU tags the two pieces of control information with time information, the gateway ECU has no timer synchronization unit. Because the gateway ECU 5012 and the gateway ECU 5023 do not perform the timer synchronization operation, their overhead can be reduced.

Further, in this embodiment since the time information attached to the control information are subjected to the time comparison processing twice by the time comparison units 5112 and 5122, the range in which system errors can be detected is widened, making the system errors more easily detectable.

### EMBODIMENT 3

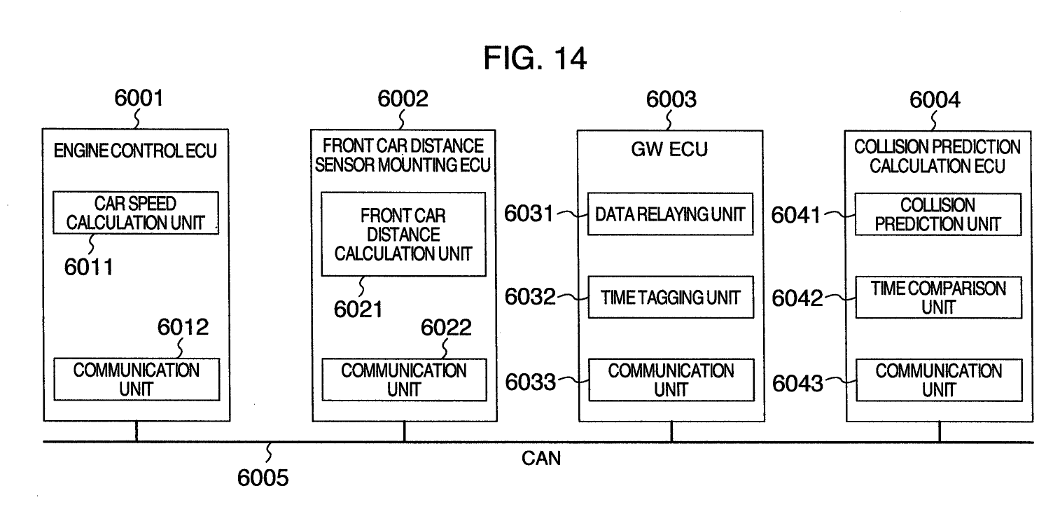

An example of an automotive control system having the similar processing to those of embodiment 1, 2 but differing in configuration from embodiment 1, 2 is shown in FIG. 14.

The automotive control system of FIG. 14 includes an engine control ECU 6001, a front car distance sensor mounting ECU 6002, a gateway ECU 6003, a collision prediction calculation ECU 6004 and a CAN 6005 connecting these ECUs. The engine control ECU 6001 has a vehicle speed calculation unit 6011 and a communication unit 6012; the front car distance sensor mounting ECU 6002 has a front car distance calculation unit 6021 and a communication unit 6022; the gateway ECU 6003 has a data relaying unit 6031, a time tagging unit 6032 and a communication unit 6033; and the collision prediction calculation ECU 6004 has a collision prediction unit 6041, a time comparison unit 6042 and a communication unit 6043.

Unlike embodiment 1, 2, this embodiment has the engine control ECU 6001, the front car distance sensor mounting ECU 6002 and the collision prediction calculation ECU 6004 installed on the same network. The engine control ECU 6001 sends the vehicle speed information calculated by the vehicle speed calculation unit 6011 to the CAN 6005 by using the communication unit 6012. The front car distance sensor mounting ECU 6002 sends the front car distance information calculated by the front car distance calculation unit 6021 to the CAN 6005. The gateway ECU 6003 receives the vehicle speed information and the front car distance information by the communication unit 6033 and then tags these control information with time information by the time tagging unit 6032. Then the data relaying unit 6031 in the gateway ECU 6003 determines a destination according to the control information, followed by the communication unit 6033 sending the control information to the CAN 6005. The collision prediction calculation ECU 6004 receives the time-tagged vehicle speed information and front car distance information through the communication unit 6043 and then compares the time information by the time comparison unit 6042. The time comparison unit 6042 decides that the control information are abnormal when the difference between these time information is in excess of a predetermined value.

In this embodiment, the gateway ECU 6003 determines the destinations of the control information and all other ECUs send their control information to the gateway ECU 6003. By concentrating the destination determination operations in one ECU, the destinations of the control information can be managed easily. Since the control information is collected from ECUs and tagged with the time at which they are received, the traffic on the CAN 6005 does not increase.

As explained above by referring to a plurality of embodiments, in this invention the gateway control unit is provided with a function of tagging the received control information with time information and sending it again on the network. Then another gateway control unit that has received the time-tagged control information compares the time information of the paired control information to verify the validity of the data.

As a result, even if control processing in an integrated control system stops due to an ECU failure and the control information fails to be transmitted, the gateway control unit can verify the validity of the control information. According to embodiment 1 and 2, no time information is transmitted over the network that connects a control information sending ECU and a gateway control unit and which does not include time information. Therefore, with this invention any system anomaly can be detected without changing the traffic on the network between the ECU, that transmits control information not containing time information, and the gateway control unit.

Further, if this invention is applied to an already developed system that does not send time information over a network, since no time information flows over the network connecting an ECU, that transmits control information, and a gateway control unit, a system error can be detected without having to redesign the ECU or communication data transmitted over the network.

### INDUSTRIAL APPLICABILITY

Comparison is made between time information attached to two pieces of control information and, from the resultant difference, the validity of the control information is determined, as performed by the time comparison unit 313 of FIG. 10. If the control information is found to be abnormal, the car condition information at that time may be saved as a log, or the detection of anomaly may be notified to other ECUs to stop their function of using the control information that has been determined as faulty. It is also possible to prevent the control information that has been found to be erroneous from being transmitted over the network or used in control processing. This improves the safety of the automotive control system.

It should be further understood by those skilled in the art that although the foregoing description has been made on embodiments of the invention, the invention is not limited thereto and various changes and modifications may be made without departing from the spirit of the invention and the scope of the appended claims.

1. A control unit for gateway used in an automotive control system, wherein the automotive control system has a plurality of control units and a network connecting the plurality of control units and compares time information attached to a plurality of pieces of control information flowing on the network to verify a validity of the plurality of pieces of control information, the control unit for gateway comprising at least one of two units:
a time tagging unit which receives a plurality of pieces of control information transmitted from one of the plurality of control units and tags them with time information; and
a time information comparison unit which makes comparison between a plurality of pieces of the time information that the time tagging unit has attached to the plurality of pieces of control information received.

2. A control unit for gateway according to claim 1, wherein the automotive control system comprises a plurality of subsystems each having one or more control units and an event-triggered network connecting the control units, and an inter-subsystem network connecting the subsystems;
wherein the control unit for gateway belongs to one of the plurality of subsystems and relays the plurality of pieces of control information from the event-triggered network to the inter-subsystem network;
wherein the time tagging unit attaches the time information to the plurality of pieces of control information when the plurality of pieces of control information are relayed from the event-triggered network to the inter-subsystem network.

3. A control unit for gateway according to claim 2, further comprising:
a time synchronization unit which synchronizes the control unit for gateway with control units for gateway belonging to other subsystems.

4. A control unit for gateway according to claim 1, which compares the plurality of pieces of time information by the time information comparison unit and, if a resultant difference is greater than a predetermined threshold, decides that the plurality of pieces of control information compared are not valid.

5. A control unit for gateway according to claim 1, wherein, when the time information comparison unit compares first time information and second time information and if the control unit for gateway receives the control information containing the first time information but cannot receive the control information containing the second time information, it decides that the control information are not valid.

6. A control unit for gateway according to claim 2, wherein the inter-subsystem network is a time-triggered network.

7. A control unit for gateway according to claim 6, which has a unit to determine a time reference for signals flowing on the time-triggered network between the control units for gateway connected to the network and to synchronize times among the control units for gateway.

8. A control unit for gateway according to claim 2, wherein the automotive control system has a unit which synchronizes times among the control units for gateway connected to the inter-subsystem network by having one of the control units for gateway transmit a synchronization reference signal to the inter-subsystem network and the other control units for gateway adjust their own times according to the received reference signal.

9. A control unit for gateway according to claim 1, which is a control unit to perform an automotive control operation other than a data relaying operation.

10. A control unit for gateway according to claim 1, which, after the comparison has been made by the time information comparison unit, removes the time information from the control information.

11. A control unit for gateway according to claim 10, which sends the control information removed of the time information to the event-triggered network.

12. A control unit for gateway used in an automotive control system according to claim 1, wherein the time information comparison unit is provided in a control unit, other than the control units for gateway, which is intended to execute a particular automotive control operation.

13. A control unit for gateway according to claim 1, which, based on a result of the comparison made by the time information comparison unit, detects an error state of the automotive control system or old control information.

14. An automotive control system comprising a plurality of control units and a network connecting the plurality of control units and comparing time information attached to a plurality of pieces of control information flowing on the network to verify a validity of the plurality of pieces of control information;
wherein one of the plurality of control units receives a plurality of pieces of control information transmitted from other one of the plurality of control units and tags them with time information;
wherein one of the plurality of control units, other than the one which has tagged the time information, compares the plurality of pieces of time information tagged to the plurality of pieces of control information received.

15. An automotive control system according to claim 14, comprising:
a plurality of subsystems each having one or more control units, an event-triggered network connecting the control units, and a control unit for gateway for relaying a plurality of pieces of control information to an outside of the event-triggered network; and
an inter-subsystem network connecting the subsystems via the control unit for gateway;
wherein the control unit for gateway tags the plurality of pieces of control information with time information when it relays the plurality of pieces of control information from the event-triggered network to the inter-subsystem network.

16. An automotive control system according to claim 15, wherein the inter-subsystem network is a time-triggered network.

17. An automotive control system according to claim 15, wherein the control unit for gateway synchronizes its time with times of other control units for gateway.

18. A subsystem comprising:
one or more control units;
a network for connecting the control units; and
a control unit for gateway for relaying a plurality of pieces of control information to an outside of the network;
wherein the control unit for gateway has at least one of a time tagging unit and a time information comparison unit, the time tagging unit receiving the plurality of pieces of control information transmitted from the control units and tagging them with time information, the time information comparison unit comparing the time information that the time tagging unit has attached to the plurality of control information received to verify a validity of the plurality of pieces of control information.

19. A subsystem according to claim 18, wherein the network is an event-triggered network;
wherein the time tagging unit attaches the time information to the plurality of pieces of control information when the plurality of pieces of control information are relayed from the event-triggered network through the time-triggered network to other subsystem.

20. A subsystem according to claim 19, which, based on a signal flowing on the time-triggered network, synchronizes its time with times of the control units for gateway in other subsystems connected to the time-triggered network.
